(19) United States
(12) Patent Application Publication
(10) Pub. No.: US 2012/0067851 A1
(43) Pub. Date: Mar. 22, 2012

(54) ONE-SIDED SPOT WELDING DEVICE

(75) Inventor: So Young Lee, Seoul (KR)

(73) Assignee: HYUNDAI MOTOR COMPANY, Seoul (KR)

(21) Appl. No.: 13/172,055

(22) Filed: Jun. 29, 2011

(30) Foreign Application Priority Data
Sep. 16, 2010 (KR) 10-2010-0091078

(51) Int. Cl. B23K 11/11

(52) U.S. Cl. 219/86.9

(57) ABSTRACT

A one-sided spot welding device of the present invention includes a gun body portion including: an upper body disposed at an end of an arm of a robot and a hollow lower body disposed at a lower portion of the upper body; a power supply portion disposed within the lower body, a welding electrode portion i) disposed at a lower side of the lower body, ii) supplied welding power from the power supply portion, and iii) configured to weld welding base metals together by electrical resistance welding; a coated metal band supply portion supplying a coated metal band between the welding base metal and the welding electrode; and a ground electrode portion, electrically connected to the power supply portion and disposed at the other lower side of the lower body for contacting the welding base metal.

### CROSS-REFERENCE TO RELATED APPLICATION

This application claims priority to and the benefit of Korean Patent Application No. 10-2010-0091078 filed in the Korean Intellectual Property Office on Sep. 16, 2010, the entire contents of which are incorporated herein by reference.

### BACKGROUND OF THE INVENTION

(a) Field of the Invention

The present invention relates to a spot welding device. More particularly, the present invention relates to a one-sided spot welding device that may form high heat input to a welding metal base, which has high electric conductivity such as aluminum, and weld together from a single side.

(b) Description of the Related Art

Typical spot welding is widely used for joining various metal sheets, and the spot welding requires electrical current to melt materials to be joined and pressure be exerted to maintain contact the parts at the welding spot during the application of the welding current forming electrical resistance to generate welding heat.

For realizing the spot welding, a spot welding device is used, and the spot welding device may be generally divided into either a two-sided spot welding device which includes a fixed electrode and a moving electrode pressing a base metal or a one-sided welding device (single-sided welding device) including a single welding electrode.

In the case of spot welding for aluminum, aluminum has relatively high electric conductivity and it is difficult to generate sufficient resistance. As such, melting of the parts to be welded at the weld spot is not sufficient. Accordingly, tensile strength of the weld spot is relatively weak and frequent dressing is required due to contamination of an electrode.

Meanwhile, for spot welding of an aluminum plate, current more than 25 kA is supplied, and in this case, distortion of the welding spot due to high heat may occur, and a large amount of spatter may be generated.

Mechanical joining methods for aluminum, such as self piercing riveting or clinching, also may be applied, but joinability of the weld zone is relatively weak. Additionally, the self piercing riveting method requires heavy devices and expensive rivets.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a one-sided spot welding device having advantages of generating contact resistance using a coated metal band supplied during welding to form high heat input so as to enhance joinability of the weld zone.

Also, the present invention may not require a general ground wire by equipping a ground electrode together with welding electrode to a gun body portion so as to stable ground near the welding zone.

A one-sided spot welding device according to an exemplary embodiment of the present invention may include: a gun body portion including an upper body disposed at an end of an arm of a robot and a hollow lower body disposed at a lower portion of the upper body; a power supply portion disposed within the lower body; a welding electrode portion i) disposed at a lower side of the lower body, ii) supplied welding power from the power supply portion, and iii) configured to weld welding base metals together by electrical resistance welding; a coated metal band supply portion supplying a coated metal band to between the welding base metal and the welding electrode; and a ground electrode portion, electrically connected to the power supply portion and disposed at the other lower side of the lower body for contacting the welding base metal.

The welding electrode portion may include: a shank which is mounted to a side of the lower body and electrically connected to the power supply portion to be supplied welding power; and a welding electrode disposed to an end of the shank.

The welding electrode may include alumina dispersion strengthened copper.

The coated metal band supply portion may include: a band supply motor disposed to a side of the upper body; a band take up motor disposed the other side of the upper body; a band supply pulley which is connected to the band supply motor and supplies the coated metal band; a band take up pulley which is connected to the band take up motor and takes up the coated metal band released from the band supply pulley; and a band guide means which is disposed at the lower body and the welding electrode portion to guide the coated metal band to the end of the welding electrode.

The band guide means may include: guide brackets which are formed to sides of the lower body and the welding electrode portion to guide the coated metal band; and a guide cap disposed to the welding electrode to guide the coated metal band to an end of the welding electrode.

The band supply motor and the band take up motor may be a servo motor of which controlling rotation speed and rotating direction is available.

The coated metal band may be a steel band of which nickel layer or copper layer is coated.

The ground electrode portion may include: a rotating bracket disposed to the other side of the lower body; a rotating motor disposed to a side of the rotating bracket; a pressure control means connected to a shaft of the rotating motor through a rotating block; and a ground electrode which is disposed at an end of the pressure control means and contacts the welding base metal.

The rotating motor may be a servo motor of which controlling rotation speed and rotating direction is available.

The pressure control means may include: a pressurizing housing connected to the shaft of the rotating motor through the rotating block; a screw motor which is connected to a screw rod, disposed within the pressurizing housing and rotates or reversely rotates according to control signals receives from a controller; a moving block engaged with the screw rod; a load cell which is disposed under the moving block, detects pressure of the ground electrode to the welding base metal and outputs pressure signal to the controller; a connecting rod which is disposed within the pressurizing housing and connected to the ground electrode through the pressurizing housing; and a pressurizing spring which is disposed within the pressurizing housing supplying elastic force to the load cell and the connecting rod.

The screw motor may be a servo motor of which controlling rotation speed and rotating direction is available.

The load cell may be formed by a piezoelectric element.

The controller may include a control logic which maintains the pressure of the ground electrode to the welding base metal constantly by controlling the screw motor to rotate or reversely rotate according to detected signals of the load cell.

An upper portion of the upper body of the gun body portion may be connected to the end of the arm of the robot through a robot bracket and an upper portion of the lower body may be connected to a lower portion of the upper body.

According to the present invention, the one-sided spot welding device may weld by interposing the coated metal band to generate additional resistance to form high heat input. Accordingly, joinability of the weld zone may be enhanced.

Moreover, the ground electrode may be equipped close to the welding electrode and stable grounding may be possible without a ground wire.

According to the present invention, the one-sided spot welding device may not require high current more than 25 kA for welding materials with high electric conductivity such as aluminum, may reduce contamination of electrode, and may minimize distortion of the welding spot due to high heat and a large amount of spatter.

### BRIEF DESCRIPTION OF THE DRAWINGS

FIG. 1 is a perspective view of a welding robot system equipped with a one-sided spot welding device according to an exemplary embodiment of the present invention.

FIG. 2 is an upper perspective view of a one-sided spot welding device according to an exemplary embodiment of the present invention.

FIG. 3 is a lower perspective view of a one-sided spot welding device according to an exemplary embodiment of the present invention.

FIG. 4 is a cross sectional side view of a one-sided spot welding device according to an exemplary embodiment of the present invention.

FIG. 5 is a cross-sectional view along line A-A of FIG. 4.

FIG. 6 is a cross-sectional view along line B-B of FIG. 4.

FIG. 7 is an enlarged cross-sectional view of a coated metal band applied to a one-sided spot welding device according to an exemplary embodiment of the present invention.

FIG. 8 and FIG. 9 are drawings showing operation states of a one-sided spot welding device according to an exemplary embodiment of the present invention.

### DESCRIPTION OF SYMBOLS

1: one-sided spot welding device;
3: robot;
5: arm;
10: gun body portion;
20: power supply portion;
30: welding electrode portion;
40: coated metal band supply portion;
50: ground electrode portion;
11: upper body;
13: lower body;
7: robot bracket;
31: welding electrode;
33: shank;
B: coated metal band;
M1: band supply motor;
M2: band take up motor;
P1: band supply pulley;
P2: band take up pulley;
61: guide bracket;
63: guide cap;
B1: steel band;
B2: nickel coated layer;
B3: copper coated layer;
51: ground electrode;
53: rotating bracket;
M3: rotating motor;
55: rotating block;
71: pressurizing housing;
M4: screw motor;
80: controller;
73: moving block;
75: load cell;
77: connecting rod;
79: pressurizing spring; and
91,93: aluminum plate.

### DETAILED DESCRIPTION OF THE EMBODIMENTS

Hereinafter, an exemplary embodiment of the present invention will be described in detail with reference to the accompanying drawings.

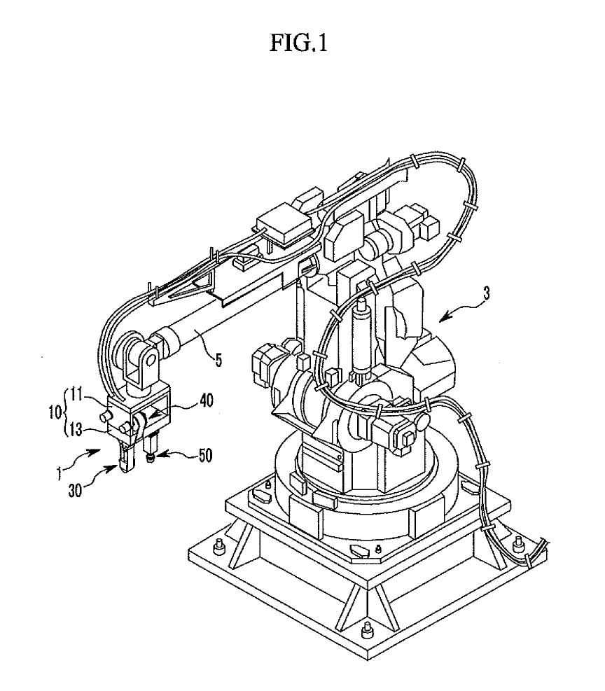

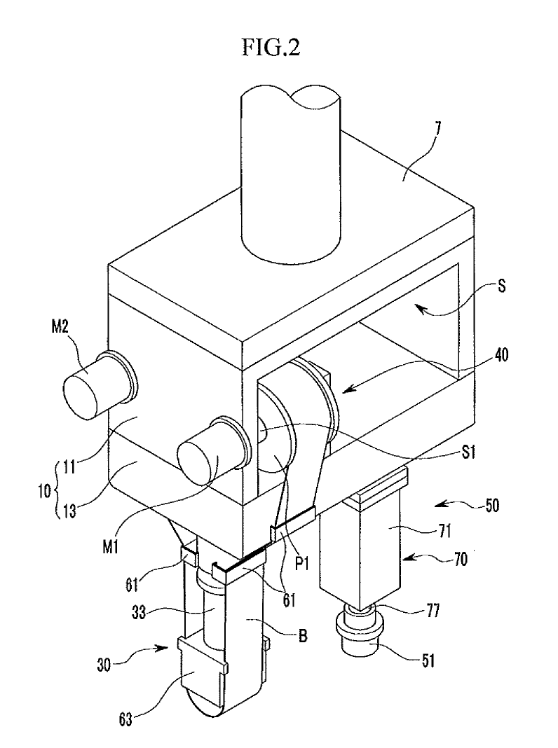

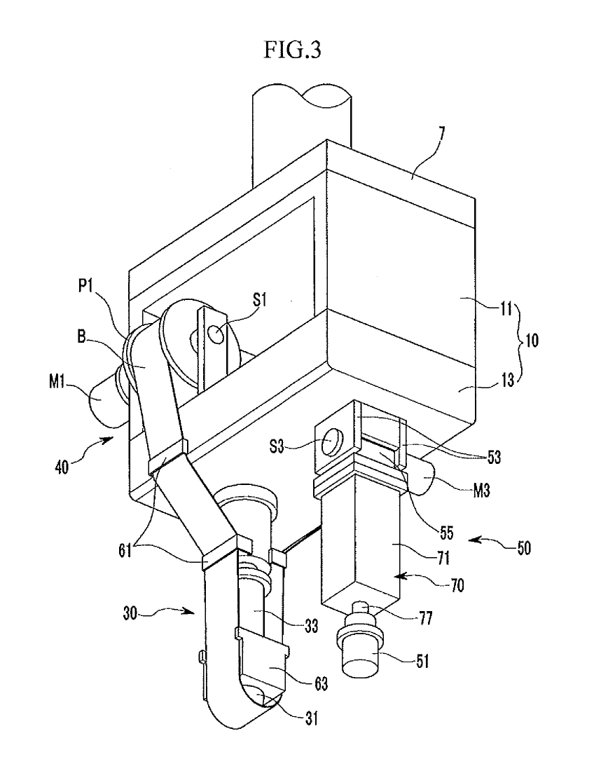

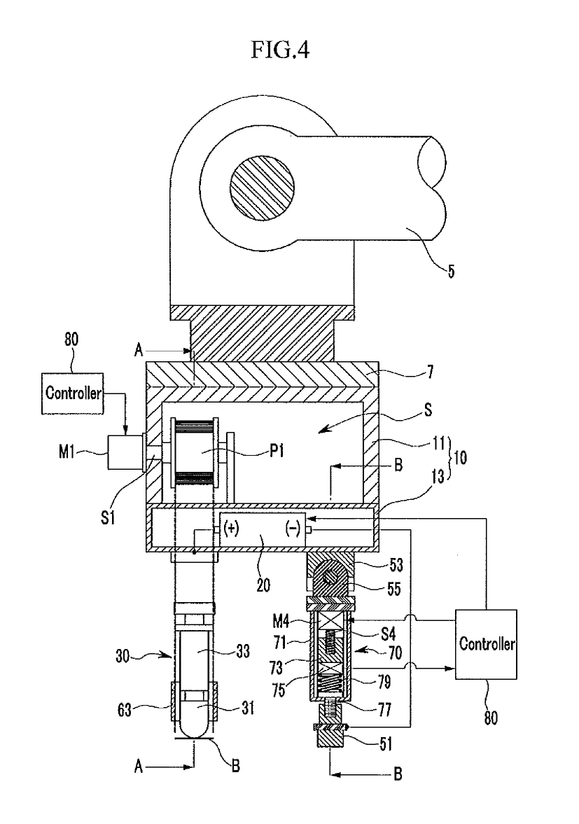

FIG. 1 is a perspective view of a welding robot system equipped with a one-sided spot welding device according to an exemplary embodiment of the present invention and FIG. 2 is an upper perspective view of a one-sided spot welding device according to an exemplary embodiment of the present invention. FIG. 3 is a lower perspective view of a one-sided spot welding device according to an exemplary embodiment of the present invention and FIG. 4 is a cross sectional side view of a one-sided spot welding device according to an exemplary embodiment of the present invention.

A one-sided spot welding device 1 according to an exemplary embodiment of the present invention, as shown in FIG. 1, disposed at an end of an arm 5 of a welding robot 3, is applied to weld materials with high electric conductivity such as aluminum from single side.

The one-sided spot welding device 1, as shown in FIG. 2 to FIG. 4, includes a gun body portion 10, a power supply portion 20, a welding electrode portion 30, a coated metal band supply portion 40 and a ground electrode portion 50.

The gun body portion 10 includes an upper body 11 disposed at an end of the arm 5 of the robot 3 and a hollow lower body 13 disposed at a lower portion of the upper body 11.

An upper part of the upper body 11 is connected to the end of the arm 5 of the robot 3 via a robot bracket 7 and a space S is formed inside of the upper body 11.

The lower body 13, as shown in FIG. 4, is hollow and the power supply portion 20 is disposed within the lower body 13.

The welding electrode portion 30 is equipped to a side of a lower portion of the lower body 13 and receives welding power from the power supply portion 20 for electrical resistance welding of welding base metal e.g. aluminum plate with a welding electrode 31.

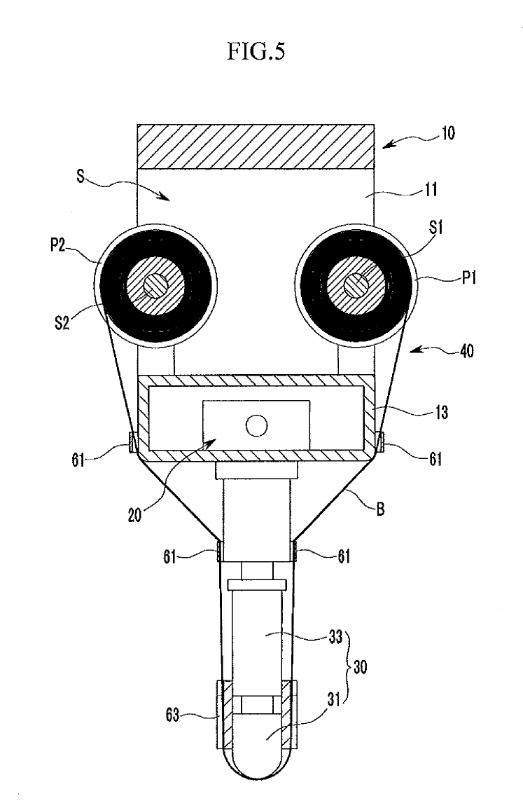

The welding electrode portion 30, as shown in FIG. 5, includes a shank 33 equipped to a side of the lower portion of the lower body 13 and the shank 33 is electrically connected to the power supply portion 20 to receive welding power.

The welding electrode 31 is disposed to an end of the shank 33 and the welding electrode 31 may be formed by alumina dispersion strengthened copper (Al₂O₃—Cu) electrode, but is not limited thereto.

The coated metal band supply portion 40 is disposed between the upper body 11 and the lower body 13 for supplying a coated metal band B between the welding electrode 31 and the welding base metal, for example aluminum plate.

The coated metal band supply portion 40, as shown in FIG. 5, includes a band supply motor M1 disposed a side of the upper body 11 and a band take up motor M2 disposed opposite side of the upper body 11.

The band supply motor M1 and band take up motor M2 may be a servo motor of which controlling rotation speed and rotating direction is available, but is not limited thereto.

The coated metal band supply portion 40 further includes the coated metal band B supplied to between the welding electrode 31 and the welding base metal, for example aluminum plate.

The coated metal band B is coiled around a band supply pulley P1 and the band supply pulley P1 is connected to a shaft S1 of the band supply motor M1 within the space S of the upper body 11.

A band take up pulley P2 is connected to a shaft S2 of the band take up motor M2 within the space S of the upper body 11, and the band take up pulley P2 takes up the coated metal band B released from the band supply pulley P1.

A band guide means is configured to the lower body 13 and the welding electrode portion 30 for guiding the coated metal band B to an end of the welding electrode 31.

The band guide means includes guide brackets 61 which are formed to sides of the lower body 13 and the welding electrode portion 30 to guide the coated metal band B and a guide cap 63 disposed to the welding electrode 31 to guide the coated metal band B to the end of the welding electrode 31.

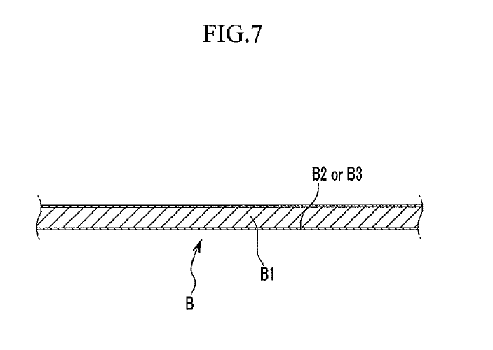

The coated metal band B, as shown in FIG. 7, may be a steel band B of which nickel layer B2 or copper layer B3 is coated, but is not limited thereto.

The ground electrode portion 50 is disposed to the other side of the lower body 13, electrically connected to the power supply portion 20 and earths (grounds) the welding base metal such as aluminum plate through ground electrode 51.

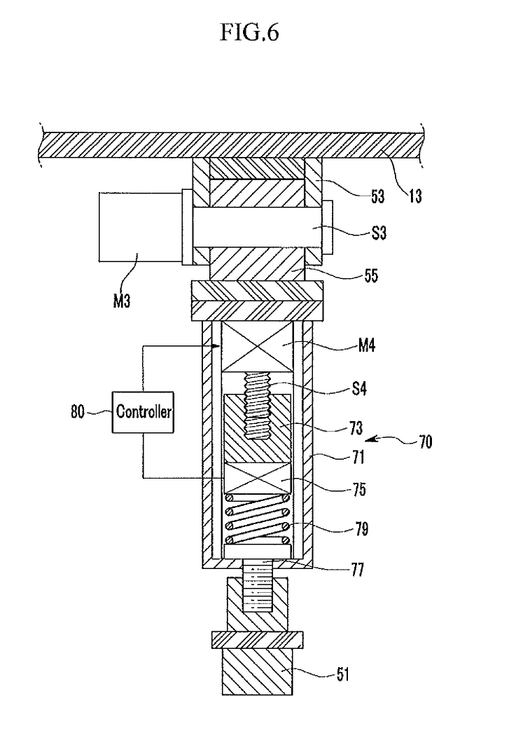

The ground electrode portion 50, as shown in FIG. 3 and FIG. 6, includes a rotating bracket 53 disposed under the lower body 13 and a rotating motor M3 disposed to a side of the rotating bracket 53.

The rotating motor M3 may be a servo motor of which controlling rotation speed and rotating direction is available, but is not limited thereto.

The ground electrode portion 50 further includes a pressure control means 70 connected to a shaft S3 of the rotating motor M3 through a rotating block 55 and a ground electrode 51 which is disposed to an end of the pressure control means 70 and contacts the welding base metal.

The pressure control means 70 includes a pressurizing housing 71 connected to the shaft S3 of the rotating motor M3 through the rotating block 55.

A screw motor M4 is disposed within the pressurizing housing 71 and is connected to a screw rod S4.

The screw motor M4 rotates or reversely rotates according to control signals receives from a controller 80, and may be a servo motor of which controlling rotation speed and rotating direction is available, but is not limited thereto.

In the pressurizing housing 71, a moving block 73 is engaged to the screw rod S4 and a load cell 75 is disposed under the moving block 73, and the load cell 75 detects pressure of the ground electrode 51 to the welding base metal and outputs pressure signal to the controller 80.

The pressure control means 70 further includes a connecting rod 77 which is disposed within the pressurizing housing 71 and connected to the ground electrode 51 through the pressurizing housing 71 and a pressurizing spring 79 which is disposed within the pressurizing housing 71 supplying elastic force to the load cell 75 and the connecting rod 77.

The load cell 75 may be a piezoelectric element.

The controller 80 includes a control logic which maintains the pressure of the ground electrode 51 to the welding base metal constantly by controlling the screw motor M4 to rotate or reversely rotate according to detected signals of the load cell 75.

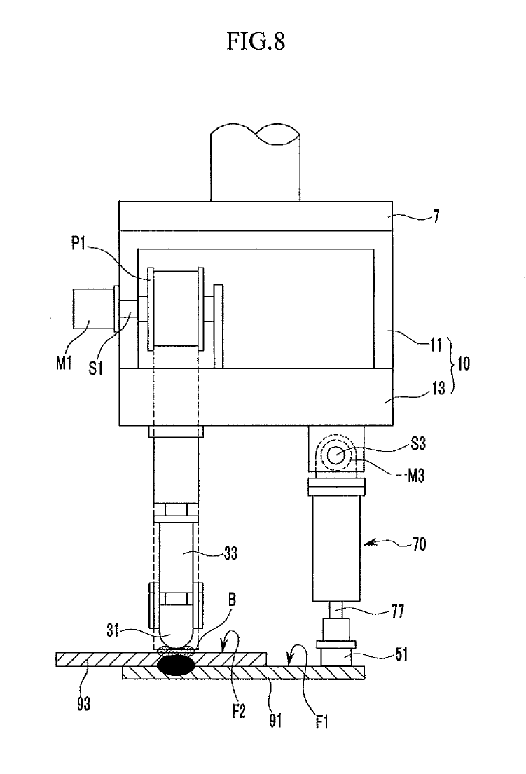

In spot welding of the one-sided spot welding device 1 according to the exemplary embodiment of the present invention, as shown FIG. 8, the robot (3) is controlled for the ground electrode 51 to contact to a side of a lower aluminum plate 91.

After the ground electrode 51 contacts to the lower aluminum plate 91, the welding electrode 31 pushes an upper aluminum plate 93 and welding power is supplied from the power supply portion 20 to the welding electrode 31.

The coated metal band B, supplied to between the welding electrode 31 and the upper aluminum plate 93, generates additional contact resistance to produce high input heat on the parts of the upper and lower aluminum plate 93 and 91 to be welded.

After the spot welding, the band supply motor M1 and the band take up motor M2 are operated simultaneously to move the coated metal band B of which a welding nugget is formed corresponding to the welding electrode 31 in order to prepare for the next spot welding.

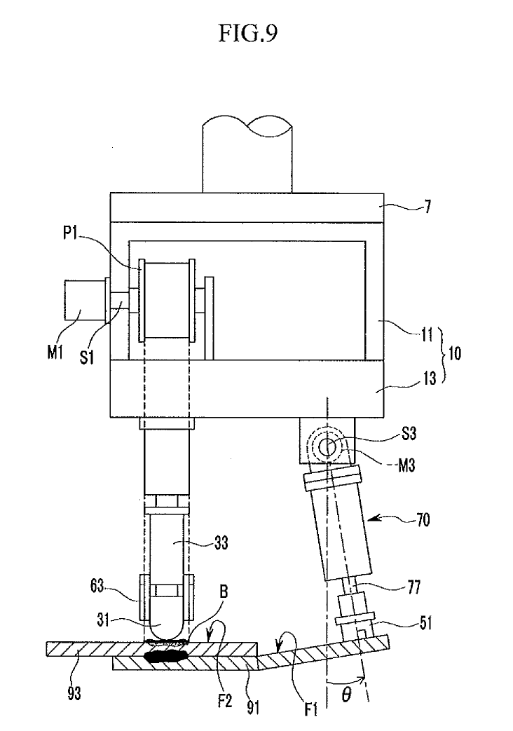

In FIG. 9, operations of the ground electrode portion 50 are described when a ground surface F1 of the lower aluminum plate 91 is slanted.

When the ground surface F1 is slanted against a welding surface F2, the rotating motor M3 is operated to rotate at angle θ for the ground electrode 51 to be vertically in contact with the ground surface F1.

The robot 3 is operated (moved and located) for the ground electrode 51 to contact to the lower aluminum plate 91, the welding electrode 31 pushes the upper aluminum plate 93 and the welding power is supplied from the power supply portion 20 to the welding electrode 31 for the upper and lower aluminum plate 93 and 91 to be welded together.

The ground electrode 51 pushes the ground surface F1 the lower aluminum plate 91 with constant pressure by operation of the pressure control means 70. That is, the screw motor M4 rotates or reversely rotates according pressure changes detected by the load cell 75 to control positions of the moving block 73.

And thus, the moving block 73 controls compressed amount of the pressurizing spring 79 to maintain pressure of the ground electrode 51 connected to the connecting rod 77 against the ground surface F1.

While this invention has been described in connection with that is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A one-sided spot welding device comprising:
a gun body portion including an upper body disposed at an end of an arm of a robot and a hollow lower body disposed at a lower portion of the upper body;
a power supply portion disposed within the lower body;
a welding electrode portion disposed at a lower side of the lower body, supplied welding power from the power supply portion, and configured to weld welding base metals together by electrical resistance welding;
a coated metal band supply portion supplying a coated metal band between the welding base metal and the welding electrode; and
a ground electrode portion, electrically connected to the power supply portion and disposed at the other lower side of the lower body for contacting the welding base metal.

2. The one-sided spot welding device of claim 1, wherein the welding electrode portion comprising:
a shank which is mounted to a side of the lower body and electrically connected to the power supply portion to be supplied welding power; and
a welding electrode disposed to an end of the shank.

3. The one-sided spot welding device of claim 1, wherein the welding electrode comprises alumina dispersion strengthened copper.

4. The one-sided spot welding device of claim 1, wherein the coated metal band supply portion comprises:
a band supply motor disposed to a side of the upper body;
a band take up motor disposed the other side of the upper body;
a band supply pulley which is connected to the band supply motor and supplies the coated metal band;
a band take up pulley which is connected to the band take up motor and takes up the coated metal band released from the band supply pulley; and
a band guide means which is disposed at the lower body and the welding electrode portion to guide the coated metal band to the end of the welding electrode.

5. The one-sided spot welding device of claim 4, wherein the band guide means comprises:
guide brackets which are formed to sides of the lower body and the welding electrode portion to guide the coated metal band; and
a guide cap disposed to the welding electrode to guide the coated metal band to an end of the welding electrode.

6. The one-sided spot welding device of claim 4, wherein the band supply motor and the band take up motor is a servo motor configured to control rotation speed and rotating direction.

7. The one-sided spot welding device of claim 1, wherein the coated metal band is a steel band of which one of either a nickel layer or a copper layer is coated.

8. The one-sided spot welding device of claim 1, wherein the ground electrode portion comprises:
a rotating bracket disposed to the other side of the lower body;
a rotating motor disposed to a side of the rotating bracket;
a pressure control means connected to a shaft of the rotating motor through a rotating block; and
a ground electrode which is disposed at an end of the pressure control means and contacts the welding base metal.

9. The one-sided spot welding device of claim 8, wherein the rotating motor is a servo motor configured to control rotation speed and rotating direction.

10. The one-sided spot welding device of claim 8, wherein the pressure control means comprises:
a pressurizing housing connected to the shaft of the rotating motor through the rotating block;
a screw motor which is connected to a screw rod, disposed within the pressurizing housing and rotates or reversely rotates according to control signals receives from a controller;
a moving block engaged with the screw rod;
a load cell which is disposed under the moving block, detects pressure of the ground electrode to the welding base metal and outputs pressure signal to the controller;
a connecting rod which is disposed within the pressurizing housing and connected to the ground electrode through the pressurizing housing; and
a pressurizing spring which is disposed within the pressurizing housing supplying elastic force to the load cell and the connecting rod.

11. The one-sided spot welding device of claim 10, wherein the screw motor is a servo motor configured to control rotation speed and rotating direction.

12. The one-sided spot welding device of claim 10, wherein the load cell is formed by a piezoelectric element.

13. The one-sided spot welding device of claim 10, wherein the controller comprises a control logic which maintains the pressure of the ground electrode to the welding base metal constantly by controlling the screw motor to rotate or reversely rotate according to detected signals of the load cell.

14. The one-sided spot welding device of claim 1, wherein an upper portion of the upper body of the gun body portion is connected to the end of the arm of the robot through a robot bracket and an upper portion of the lower body is connected to a lower portion of the upper body.

15. A method for one-sided spot welding comprising:
locating a welding electrode to a weld zone on one side of a first welding base metal;
interposing a coated metal band between the welding base metal and the welding electrode;
contacting, from the same side, a second welding base metal with a ground electrode electrically connected to a power supply, the second welding based metal in contact with the first welding base metal at the weld zone; and
supplying welding power to a welding electrode by the power supply to weld the first and second welding base metals together by electrical resistance welding at the weld zone.
